(19) United States
(12) Patent Application Publication
(10) Pub. No.: US 2025/0008613 A1
(43) Pub. Date: Jan. 2, 2025

(54) MoSi2 HEATER

(71) Applicant: JX METALS CORPORATION, Tokyo (JP)

(72) Inventors: Satoyasu NARITA, Ibaraki (JP); Yuki OKADA, Ibaraki (JP); Hiroshi TAKAMURA, Ibaraki (JP)

(21) Appl. No.: 18/708,782

(22) PCT Filed: Oct. 4, 2022
(86) PCT No.: PCT/JP2022/037171

§ 371 Date: May 9, 2024

(30) Foreign Application Priority Data
Jan. 26, 2022 (JP) 2022-010165

(51) Int. Cl. H05B 3/14; H05B 3/03

(52) U.S. Cl. CPC H05B 3/148; H05B 3/03

(57) ABSTRACT

An object of this invention is to provide a MoSi₂ heater capable of preventing the peeling of the metal film formed on an electrode part, and thereby extending the service life of the heater. A MoSi₂ heater comprising a heat generating part, a terminal part, and an electrode part provided to a part of the terminal part, wherein the electrode part includes a metal film, and an oxide film having a film thickness of 2.5 μm or less is provided between the metal film and a MoSi₂ base material.

### TECHNICAL FIELD

The present invention relates to a MoSi₂ heater.

### BACKGROUND ART

As MoSi₂ (molybdenum disilicide) heaters exhibit superior oxidation resistance, they have long been used as ultra-high temperature heaters for use in air or oxidizing atmospheres, and have been used in a wide range of applications to date. This heater contains MoSi₂ as its main component, and in certain cases an insulating oxide such as SiO₂ is added to increase the electrical resistance.

MoSi₂ heaters currently being used in the glass industry, for ceramic firing and in many other fields are of various shapes and sizes as shown in FIG. 1, such as a U-shape (FIG. 1(a)), L-shape (FIG. 1(b)), W-shape or multi U-shape (FIG. 1(c)), three-dimensional U-shape (FIG. 1(d)), multi circumferential U-shape (FIG. 1(e)), and built-in insulation type (FIG. 1(f)), and these are used depending on their purpose and application.

FIG. 2 shows a schematic diagram of a U-shaped heater. While heaters come in various shapes, they are basically configured from a heat generating part 23 and a terminal part 21 at either end, and an electrode part 22, which is connected to an external power source, is provided to a part of the terminal part. When the heater is energized, the small-diameter, high-resistant part becomes a high temperature and serves as a heat generating part, and the large-diameter, low-resistant part suppresses heat generation and services as a terminal part to maintain the power feeding part at a low temperature. The diameter of the heat generating part and the diameter of the terminal part have a relationship of roughly 1:2.

With MoSi₂ heaters that are commercially available today, the diameter of the heat generating part and the diameter of the terminal part have a relationship of, for instance, φ3 mm/φ6 mm, φ4 mm/φ9 mm, φ6 mm/@12 mm, φ9 mm/@18 mm, and @12 mm/@24 mm. Moreover, the length of the electrode part is, for instance, 25 mm (diameter of the terminal part: φ6 mm, φ9 mm), 45 mm (diameter of the terminal part: φ12 mm), 75 mm (diameter of the terminal part: @18 mm), and 100 mm (diameter of the terminal part: φ18 mm). There are industry standard values for the combination of the diameter of the heat generating part and the diameter of the terminal part, or the length of the electrode part.

FIG. 3 shows an example of a method of connecting the MoSi₂ heater to an external power source. An Al braided wire 31 is connected to an electrode part 33 and fixed with a metal fitting (clamp) 32, and power is supplied from the external power source to a terminal part 34 at either end. When combined, the Al braided wire and the clamp are sometimes collectively referred to as a connection band. FIG. 3(a) is a photograph showing a state where a connection band is attached to the heater, and in this photograph the connection band is attached only to one side as a matter of convenience of explanation, but in actual use the connection band is attached to both sides. FIG. 3(b) is a schematic diagram (front view) showing a case where a connection band is attached to an electrode part of the heater and, as with FIG. 3(a), the connection band is attached only to one side as a matter of convenience of explanation. FIG. 3(c) is a diagram (plan view) of viewing FIG. 3(b) from above.

Generally speaking, with an electrode part of a MoSi₂ heater, a metal film (such as an Al sprayed film) is formed on a MoSi₂ base material in order to increase electrical conductivity. In the process of forming a metal film, blasting treatment is performed for removing the oxide film (protective film) on the surface and improving the adhesiveness of the surface, and the metal film is thereafter formed via plasma spray coating. For example, in order to prevent the deterioration of the electrode part of the heater, Patent Document 1 describes forming a metal film at a part of the electrode part where the oxide coating was removed, and overlapping the metal film also at the part where the oxide film of the terminal part has not been removed.

### PRIOR ART DOCUMENTS

### Patent Documents

[Patent Document 1] Japanese Unexamined Patent Application Publication No. 2000-48937

### DISCLOSURE OF THE INVENTION

### Problems to be Solved by the Invention

An object of the present disclosure is to provide a MoSi₂ heater capable of preventing the peeling of the metal film formed on the MoSi₂ base material of an electrode part, and thereby extending the service life of the heater.

### Means for Solving the Problems

One mode of the present invention is a MoSi₂ heater comprising a heat generating part, a terminal part, and an electrode part provided to a part of the terminal part, wherein the electrode part includes a metal film, and an oxide film having a film thickness of 2.5 μm or less is provided between the metal film and a MoSi₂ base material.

### Effect of the Invention

According to the present disclosure, a superior effect is yielded in that it is possible to prevent the peeling of the metal film formed on an electrode part, and thereby extend the service life of the heater.

### BRIEF DESCRIPTION OF THE DRAWINGS

FIG. 1 shows examples of shapes of a MoSi₂ heater.

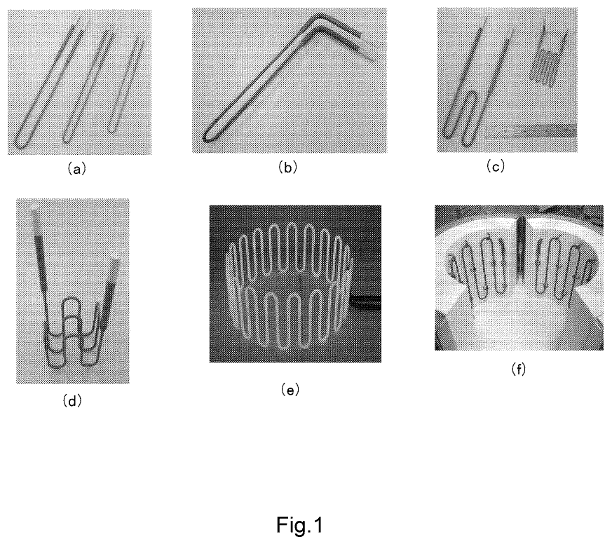

FIG. 2 is an explanatory diagram of a MoSi₂ heater (when it is a U-shape).

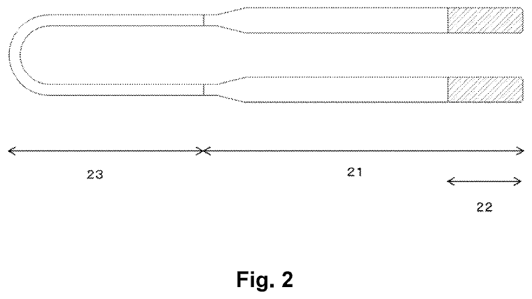

FIG. 3 is an explanatory diagram showing the attachment of a connection band to a heater electrode part.

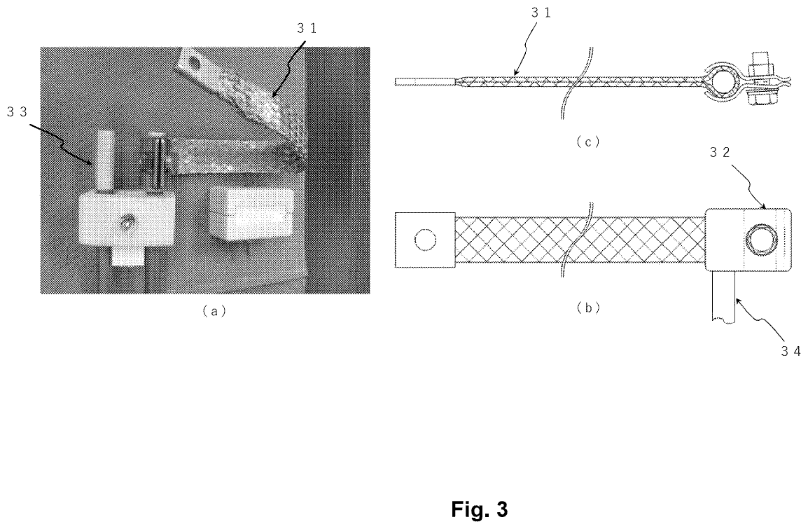

FIG. 4 is a SEM photograph showing a blast area and a non-blast area.

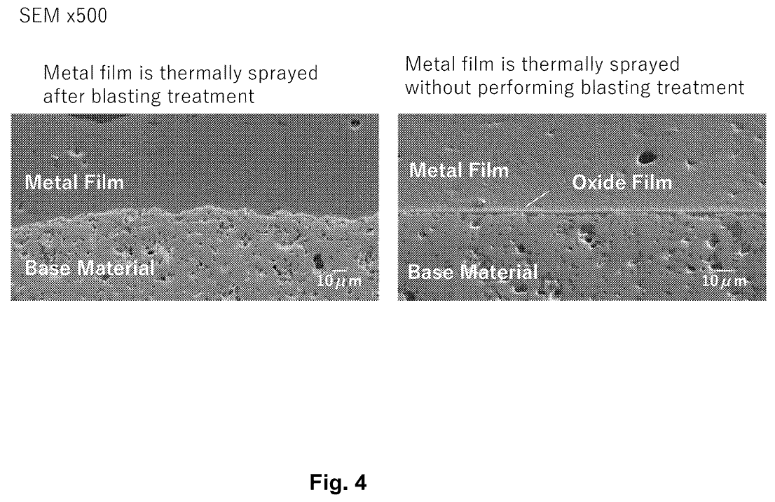

FIG. 5 is an explanatory diagram showing an example of the SEM observation points of a MoSi₂ heater.

FIG. 6 is an explanatory diagram showing an example of the measurement positions of the film thickness of an oxide film.

FIG. 7 is an explanatory diagram for determining the area ratio of an oxide film.

FIG. 8 is an explanatory diagram showing an example of the processing sequence of a MoSi₂ heater (U-shape).

FIG. 9 is a SEM image and EPMA elemental mapping of Example 1.

FIG. 10 is a SEM image and EPMA elemental mapping of Example 2.

FIG. 11 is a SEM image and EPMA elemental mapping of Comparative Example 1.

FIG. 12 is a SEM image and EPMA elemental mapping of Comparative Example 2.

FIG. 13 is a diagram showing the results of the peeling test of metal films.

### BEST MODE FOR CARRYING OUT THE INVENTION

While the terminal part of a MoSi₂ heater hardly generates heat by itself, the electrode part provided to a part of the terminal part (hereinafter sometimes referred to as the “terminal electrode part”) is located outside the insulating material, and, despite being away from the heat generating part, its temperature rises due to thermal conduction. Moreover, depending on the structure of the furnace, the terminal electrode part may be a closed space and, in such a case, since it becomes difficult to cool the terminal electrode part with outside air, its temperature tends to rise. The temperature of the terminal electrode part of the MoSi₂ heater is desirably 300° C. or less, but in certain cases it may be higher than that.

With MoSi₂, the selective oxidation of Mo occurs at 300° C. to 800° C. This is commonly known as the pest phenomenon. While metal such as Al is thermally sprayed on the electrode part, in the case of thermal spraying, because there is a limit to the density of the metal film, oxygen permeates the metal film and becomes diffused in MoSi₂. Here, the selective oxidation of Mo occurs at the interface of MoSi₂ and the metal film, whereby a gap is created, which expands over time, and may ultimately result in the peeling of the metal film. If the metal film peels off, because the electrical resistance increases in that area, the terminal part may break or become non-conductive due to abnormal heat generation or sparks.

Without limitation to MoSi₂ heaters, blasting treatment is performed before thermal spraying in order to activate the surface and improve adhesiveness. Nevertheless, the adhesiveness of the metal film is insufficient even when blasting treatment is performed, and especially when exposed to a high temperature for a long period of time, such as with the electrode part of a MoSi₂ heater, there was a problem in that the metal film would peel off due to the occurrence of pest at the thermal spray interface.

To deal with this kind of problem, when forming a metal film via thermal spraying, because a metal film is composed of flat particles, attempts were made to densify the metal film by hitting the metal film with a hammer or a ball to compress the metal film. Nevertheless, even if the metal film could be densified with these methods, the peeling of the metal film caused by pest still could not be sufficiently suppressed, and this did not directly contribute to extending the service life of the product.

In the course of performing the trial and error described above, the present inventors, etc. renewed their perception of the traditional mindset; that is, removing the oxide film, which serves as an insulator of the electrode part surface, via blasting treatment for activating the surface of the electrode part and improving the adhesiveness before performing metal thermal spraying, and discovered that an electrode part with superior high temperature durability can be obtained by causing an oxide film to be present by controlling its film thickness to be an appropriate thickness.

Based on the foregoing discovery, the MoSi₂ heater according to an embodiment of the present invention is characterized in comprising a heat generating part, a terminal part, and an electrode part provided to a part of the terminal part, wherein the electrode part includes a metal film, and an oxide film having a film thickness of 2.5 μm or less is provided between the metal film and a MoSi₂ base material.

Due to the existence of an oxide film having a certain film thickness, the oxide film and the metal film become bonded and, even when exposed to a high temperature for long hours, the peeling of the metal film can be suppressed. Furthermore, since it becomes difficult for the metal film to peel off, there will no longer be any breakage of the terminal electrode part, and the service life of the heater itself can be extended.

In this embodiment, the film thickness of the oxide film between the metal film and the MoSi₂ base material in the electrode part is 2.5 μm or less. It is thereby possible to improve the durability under high temperatures.

An oxide film can be formed via heat treatment, and with MoSi₂, normally an oxide film is formed on the surface at a temperature of roughly 1000° C. or higher. Meanwhile, when exceeding 1715° C., which is the melting point of the oxide film (cristobalite), the oxide film stops forming, and will peel off or evaporate as gas. Accordingly, the heat treatment temperature is preferably 1000° C. or higher and 1715° C. or less. The higher the heat treatment temperature, the faster the oxide film formation speed, and the longer the treating time, the thicker the oxide film.

In the present disclosure, the film thickness of the oxide film is calculated in the following manner.

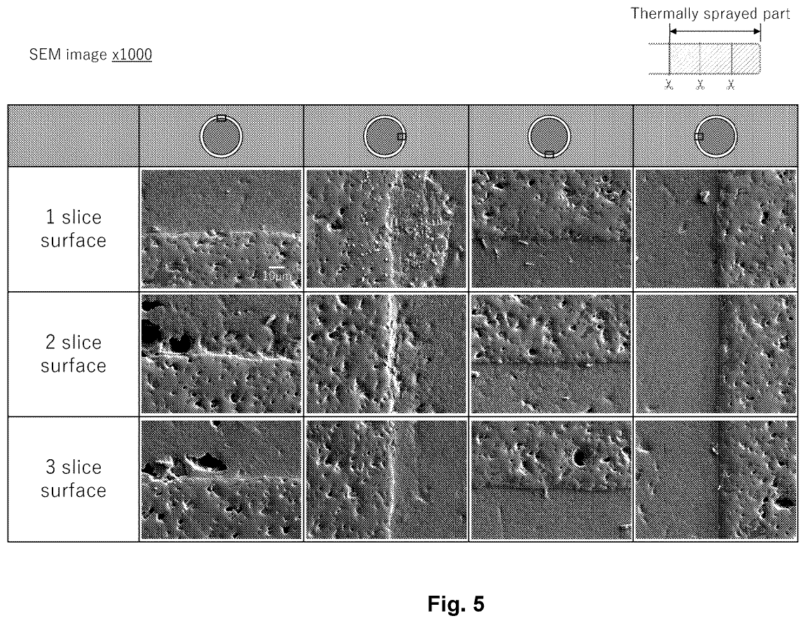

The MoSi₂ heater (electrode part) is divided into three parts at approximately equal intervals in a direction perpendicular to the longitudinal direction, and the cut surfaces are observed (magnification ratio: ×1000) clockwise at 90° each at a total of four locations using a scanning electron microscope (for example, JXA-8500F manufactured by JEOL). An example of the observation points is shown in FIG. 5. Next, each of the three cross sections is observed, and a total of twelve locations are observed. These observation points are subject to elemental analysis using an EPMA (Electron Probe Micro Analyzer), and the base material (MoSi₂), oxide film, metal film and the like configuring the interface are identified.

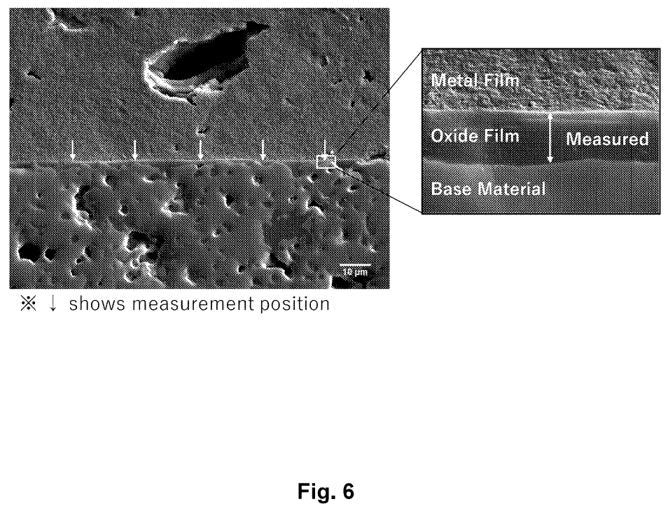

An oxide film is mainly composed of Si and O. Since pest that is formed after using a MoSi₂ heater is composed of Mo, Si and O, the two can be differentiated based on the presence or absence of Mo. The film thickness of the oxide film identified in the manner described above is measured using image processing software (e.g., ImageJ: open source, Developer: U.S. National Institutes of Health). For example, as shown in FIG. 6, the film thickness is measured at five locations at 20 μm intervals for one image, and this is performed for all image data at twelve locations. The thus obtained film thicknesses of a total of sixty locations are averaged and used as the film thickness of the oxide film in one sample.

While an oxide film is formed by subjecting MoSi₂ to heat treatment, if the heat treatment is insufficient or if blasting treatment is partially performed or due to some other reason, there may be an area in a part of the electrode part where an oxide film is not present. Nevertheless, even with an area where an oxide film is not partially present, durability under high temperatures can be improved with the presence of a certain amount of the oxide film. While there is no particular limitation to the ratio of the oxide film relative to the surface area of the electrode part, it is preferably 60% or more, more preferably 70% or more, and most preferably 80% or more.

In the present disclosure, the ratio of the oxide film relative to the surface area of the electrode part is calculated in the following manner.

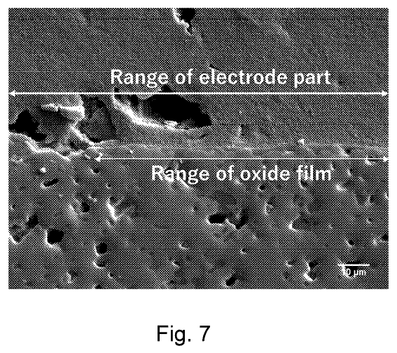

The MoSi₂ heater (electrode part) is divided into three parts at approximately equal intervals in a direction perpendicular to the longitudinal direction, and the cut surfaces are observed (magnification ratio: ×1000) clockwise at 90° each at a total of four locations using a scanning electron microscope (for example, JXA-8500F manufactured by JEOL). Each of the three cross sections is observed, and a total of twelve locations are observed. These observation points are subject to elemental analysis using an EPMA (Electron Probe Micro Analyzer), and the base material (MoSi₂), oxide film, metal film and the like configuring the interface are identified. With the oxide film identified in the manner described above, image processing software (e.g., ImageJ: open source, Developer: U.S. National Institutes of Health) is used and, as shown in FIG. 7, the range (length) of the oxide film relative to the range (length) of the electrode part in the observed image is calculated as the ratio of the oxide film relative to the surface area of the electrode part. This calculation is performed for all image data at twelve locations, the ratios of a total of twelve locations are averaged and used as the ratio of the oxide film relative to the surface area of the electrode part in one sample.

The MoSi₂ heater preferably contains 35 wt % or more of MoSi₂, more preferably contains 50 wt % or more of MoSi₂, and most preferably contains 70 wt % or more of MoSi₂.

The oxide film is preferably composed of oxide containing Si. Because the surface of MoSi₂ as the base material is configured from an oxide film mainly composed of SiO₂, unless special treatment is performed, the oxide film will be composed of oxide containing Si, but the oxide film may also contain components other than Si. For instance, Al or the like diffused from the metal film may also be partially contained in the oxide film as an oxide of Al₂O₃. Moreover, when a metal film other than Al is formed, oxide corresponding to that metal may be partially contained. It is considered that the adhesiveness can be further improved by diffusing Al or the like, from which the metal film is composed, to SiO₂, from which the oxide film is mainly composed.

While there is no particular limitation to the method of forming a metal film, for example, a metal film is preferably formed using methods such as plasma spray coating, plating, or ion plating. Moreover, while there is no particular limitation to the type of metal film, for example, the metal film is preferably composed of Al, Ni, Cr, Ti, or an alloy containing at least one or more types of these metals. Among the above, Al or Al alloy is preferably used. Moreover, there is no particular limitation to the film thickness of the metal film so as long as conduction can be ensured. For example, the film thickness of the metal film may be 100 μm or more and 300 μm or less.

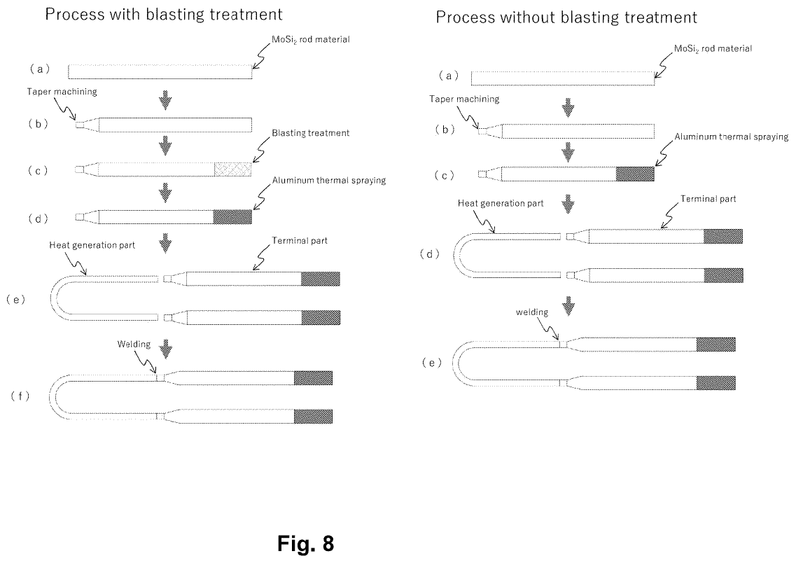

An example of the processing sequence of the MoSi₂ heater (when it is a U-shape) according to this embodiment is now explained with reference to the right diagram of FIG. 8 (process without blasting treatment). Note that the present invention is not limited to this processing, and also includes cases of being prepared with other processing methods as a matter of course.

FIG. 8(a): A raw material having MoSi₂ as its main component is molded and calcined to prepare a MoSi₂ rod material (rod shaped base material). This will later become a terminal member. While the description of the heat generating part is omitted, a MoSi₂ rod material having a diameter that is smaller than the diameter of this terminal member is prepared. There is no particular limitation to the raw material or the molding/calcination conditions, and general methods and conditions may be used. Moreover, while a case based on the powder sintering method was explained as an example, the base material may also be prepared based on other methods, such as the melting and casting method. As a result of subjecting the base material to heat treatment thereafter, an oxide film having a predetermined film thickness can be formed on the base material surface.

FIG. 8(b): One end of the MoSi₂ rod material is cut sharply into a shape like a pen tip. This will later become the part to be attached to the heat generating part. Because there is an industry standard in the relationship of the thickness of the terminal part and the thickness of the heat generating part, the diameter of the tip part can be decided accordingly. Moreover, the gradient ratio (height:length) from the terminal part to the heat generating part can also be decided as appropriate.

FIG. 8(c): Aluminum (Al) is thermally sprayed on the other end of the terminal part to form an electrode part. Here, while Al thermal spraying is described as an example, other metals and other deposition methods may also be used so as long as a metal film can be formed. Note that, in the process with blasting treatment (FIG. 8, left diagram), blasting treatment is performed before aluminum spraying.

FIG. 8(d): The MoSi₂ rod material is bent into a U-shape. This MoSi₂ rod material will ultimately become the heat generating part, and will have a thickness (diameter) that is smaller than that of the MoSi₂ rod material (terminal member) explained above. Note that, when preparing a W-shaped heater, it is sufficient to combine three U-shaped rod materials alternately in opposite directions, and a three-dimensional U-shaped or multi circumferential U-shaped heater can be prepared by three-dimensionally combining a plurality of U-shaped rod materials. Moreover, depending on the application, the heater can also be formed in a linear shape or a curved shape, rather than a U-shape.

FIG. 8(e): The terminal member that underwent Al thermal spraying (FIG. 8(c)) and the heat generating part that was bent into a U-shape (FIG. 8(d)) are welded to prepare a U-shaped MoSi₂ heater. There is no particular limitation to the welding method, and general welding methods may be used. Moreover, while a U-shape was illustrated as an example in the foregoing explanation, since it will be sufficient to weld a terminal member to either end of the heat generating part (FIG. 8(c)) to prepare a heater, the shape of the heater can be designed relatively freely by suitably combining and welding one or more heat generating parts, excluding either end.

### EXAMPLES

The present invention is now explained based on the following Examples and Comparative Examples. Note that the following Examples are merely representative examples, and the present invention is not limited to these Examples in any way. In other words, the present invention is limited only by the scope of its claims, and covers various modifications other than the Examples included in the present invention.

### (Preparation of Rod Material)

A MoSi₂ powder and a SiO₂ powder were weighted at a ratio of 94:6 wt %, mixed and pulverized using a pulverizer to achieve an average grain diameter of 2 to 5 μm, and thereafter mixed using a mixer upon adding 10 wt % of a binder. Next, the obtained mixture was molded into a rod shape using an extruder, thereafter degreased under a nitrogen atmosphere and sintered under an argon atmosphere. The molded rod shape was thereafter removed from the furnace and subject to electric current sintering in the atmosphere, and a rod material (diameter: 9 mm) was thereby obtained.

### Example 1

A rod material was cut to a length of roughly 40 mm and subject to heat treatment (in the atmosphere at 1500° C. for 150 seconds) to form an oxide film. The rod material was subject to Al plasma spray coating without undergoing blasting treatment to form a metal film having a width of 20 mm and a film thickness of 160 to 200 μm. As a result of cutting a part of the rod material and observing the longitudinal cross section thereof using SEM, the film thickness of the oxide film was 0.95 μm, and the oxide film covered the overall electrode part.

As a result of holding the prepared MoSi₂ rod material in the atmosphere at 450° C. for 22 weeks (3696 hours) and observing the peeling or non-peeling of the metal film, no peeling or cracking of the metal film was observed.

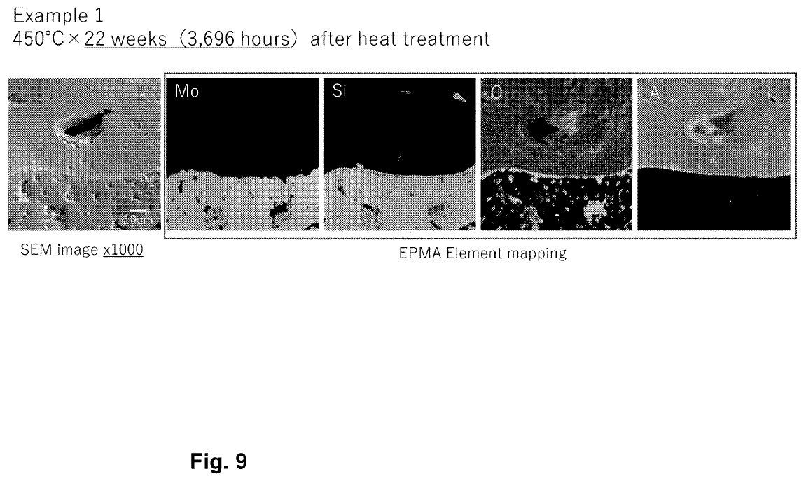

Moreover, the longitudinal cross section of the MoSi₂ rod material was observed using SEM, and the interface of MoSi₂ and the Al metal film was analyzed via elemental mapping using EPMA. The results are shown in FIG. 9. As shown in FIG. 9, no pest or the like was particularly observed at the interface.

### Example 2

A rod material was cut to a length of roughly 40 mm and subject to heat treatment (in the atmosphere at 1500° C. for 450 seconds) to form an oxide film. The rod material was subject to Al plasma spray coating without undergoing blasting treatment to form a metal film having a width of 20 mm and a film thickness of 160 to 200 μm. As a result of cutting a part of the rod material and observing the longitudinal cross section thereof using SEM, the film thickness of the oxide film was 2.5 μm, and the oxide film covered the overall electrode part.

As a result of holding the prepared MoSi₂ rod material in the atmosphere at 450° C. for 22 weeks (3696 hours) and observing the peeling or non-peeling of the metal film, no peeling or cracking of the metal film was observed.

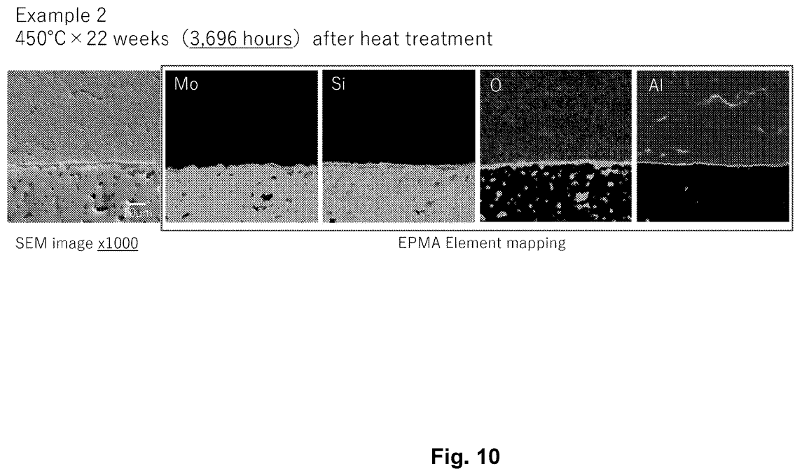

Moreover, the longitudinal cross section of the MoSi₂ rod material was observed using SEM, and the interface of MoSi₂ and the Al metal film was analyzed via elemental mapping using EPMA. The results are shown in FIG. 10. As shown in FIG. 10, no pest or the like was particularly observed at the interface.

### Comparative Example 1

A rod material was cut to a length of roughly 40 mm and subject to heat treatment (in the atmosphere at 1500° C. for 5 hours) to form an oxide film. The rod material was subject to Al plasma spray coating without undergoing blasting treatment to form a metal film having a width of 20 mm and a film thickness of 160 to 200 μm. As a result of cutting a part of the rod material and observing the longitudinal cross section thereof using SEM, the film thickness of the oxide film was 2.6 μm, and the oxide film covered the overall electrode part.

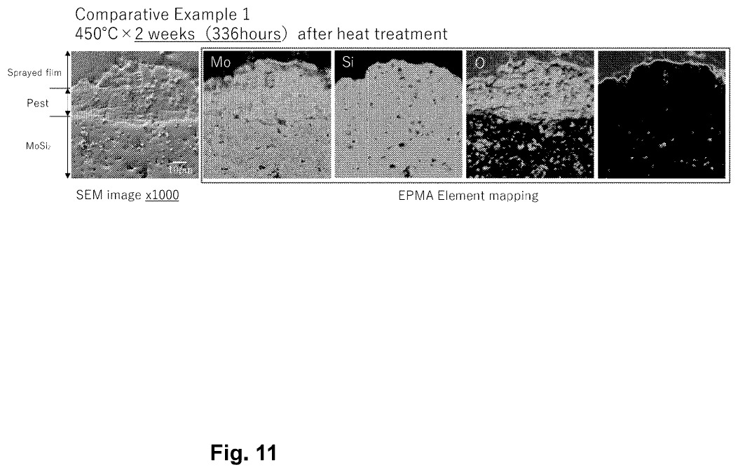

As a result of holding the prepared MoSi₂ rod material in the atmosphere at 450° C. for 22 weeks (3696 hours) and observing the peeling or non-peeling of the metal film, peeling of the sprayed film was observed, and there was pest, which could be confirmed visually, on the base material surface under the thermally sprayed part. Moreover, the longitudinal cross section of the MoSi₂ rod material was observed using SEM, and the interface of MoSi₂ and the Al metal film was analyzed via elemental mapping using EPMA. The results are shown in FIG. 11. As shown in FIG. 11, pest containing Mo was confirmed at the interface.

### Comparative Example 2

A rod material was cut to a length of roughly 40 mm and subject to heat treatment (in the atmosphere at 1500° C. for 150 seconds) to form an oxide film, and the oxide film was thereafter removed by subjecting the rod material to blasting treatment. The rod material was thereafter subject to Al plasma spray coating to form a metal film having a width of 20 mm and a film thickness of 160 to 200 μm. As a result of cutting a part of the rod material and observing the longitudinal cross section thereof using SEM, the oxide film had been almost completely removed (0 μm).

As a result of holding the prepared MoSi₂ rod material in the atmosphere at 450° C. for 22 weeks (3696 hours) and observing the peeling or non-peeling of the metal film, peeling of the metal film was observed.

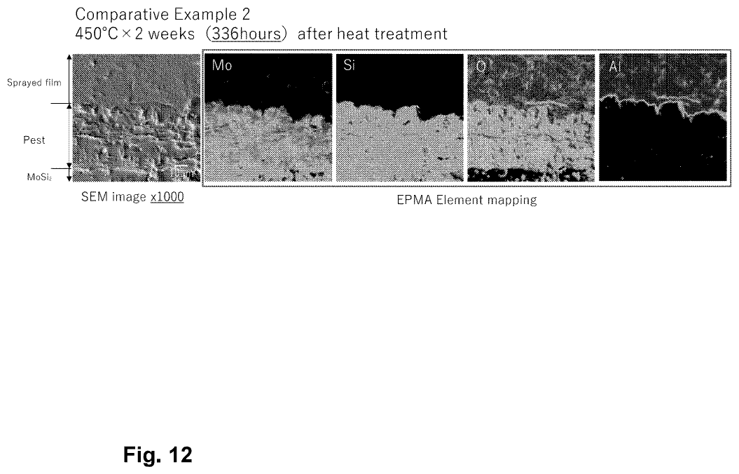

Moreover, the longitudinal cross section of the MoSi₂ rod material was observed using SEM, and the interface of MoSi₂ and the Al metal film was analyzed via elemental mapping using EPMA. The results are shown in FIG. 12. As shown in FIG. 12, pest containing Mo was confirmed at the interface.

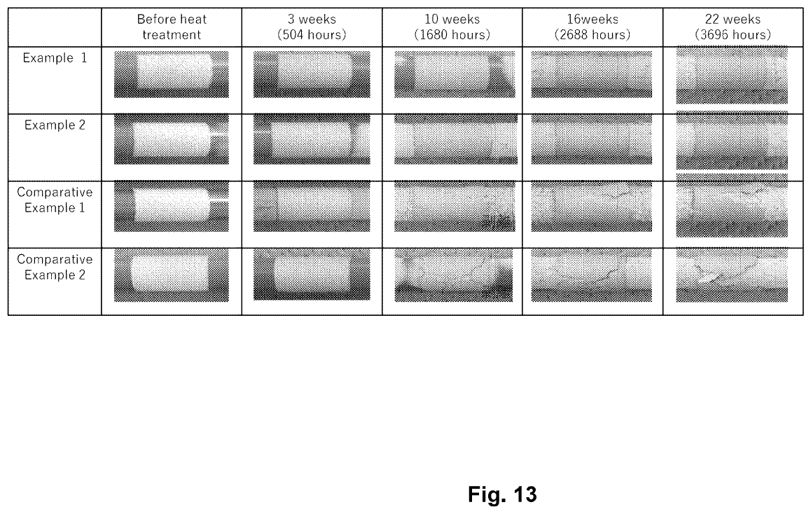

The results of the peeling test of the metal film described above are summarized in FIG. 13. Note that, when manufacturing a MoSi₂ heater as a product, while one side of the rod material (side that the metal film is not formed) having a diameter of 9 mm is processed into a pen tip shape, and thereafter welded to a U-shaped MoSi₂ material having a diameter of 4 mm to obtain the shape of a U-shaped heater, because whether or not welding is performed is unrelated in confirming the effect of the present invention, no welding was performed in the foregoing Examples.

### INDUSTRIAL APPLICABILITY

According to the present invention, a superior effect is yielded in that the peeling of the metal film formed on an electrode part in a MoSi₂ heater can be prevented, and the extension of the service life of the heater can be realized. The MoSi₂ heater according to the present invention is useful as an ultra-high temperature heater that is being used in the glass industry, ceramic firing, and various other fields.

### DESCRIPTION OF REFERENCE NUMERALS

21 terminal part
22 electrode part
23 heat generating part
31 Al braided wire
32 metal fitting (clamp)
33 electrode part
34 terminal

1. A MoSi₂ heater, comprising:
a heat generating part;
a terminal part; and
an electrode part provided to a part of the terminal part, wherein the electrode part includes a metal film,
an oxide film having a film thickness of 2.5 μm or less is provided between the metal film and a MoSi₂ base material, and
the oxide film is an oxide film mainly composed of SiO₂.

2. (canceled)

3. The MoSi₂ heater according to claim 1, wherein the metal film contains one or more types of metal elements selected from a group consisting of Al, Ni, Cr, and Ti.

4. The MoSi₂ heater according to claim 3, wherein the film thickness of the metal film is 100 μm or more and 300 μm or less.

5. The MoSi₂ heater according to claim 4, wherein the MoSi₂ heater contains 35 wt % or more of MoSi₂.

6. The MoSi₂ heater according to claim 3, wherein the MoSi₂ heater contains 35 wt % or more of MoSi₂.

7. The MoSi₂ heater according to claim 1, wherein the MoSi₂ heater contains 35 wt % or more of MoSi₂.

8. The MoSi₂ heater according to claim 1, wherein the film thickness of the metal film is 100 μm or more and 300 μm or less.
